(19) United States
(12) Patent Application Publication
(10) Pub. No.: US 2005/0053431 A1
(43) Pub. Date: Mar. 10, 2005

(54) Granular feeder

(76) Inventor: Shawn H. Lin, Atlanta, GA (US)

Correspondence Address: SMITH, GAMBRELL & RUSSELL, LLP;SUITE 3100, PROMENADE II, 1230 PEACHTREE STREET, N.E., ATLANTA, GA, 30309-3592, US

(21) Appl. No.: 10/895,746

(22) Filed: Jul. 21, 2004

Related U.S. Application Data
(60) Provisional application No. 60/489,880, filed on Jul. 24, 2003.

(51) Int. Cl. B65G 53/40

(52) U.S. Cl. 406/122

(57) ABSTRACT

The granular feeder apparatus including a chamber formed of at least one upstanding wall, a water inlet in said wall for communicating with said chamber, a water outlet in said wall, said chamber having a bottom, valve means for turning said granular feeder on and off, a flow meter connected to said chamber, a drain valve, for draining said feeder apparatus, a perforated plate, inside of and spaced from the bottom of said chamber to permit water to flow underneath and up through perforations in said plate and into said chamber.

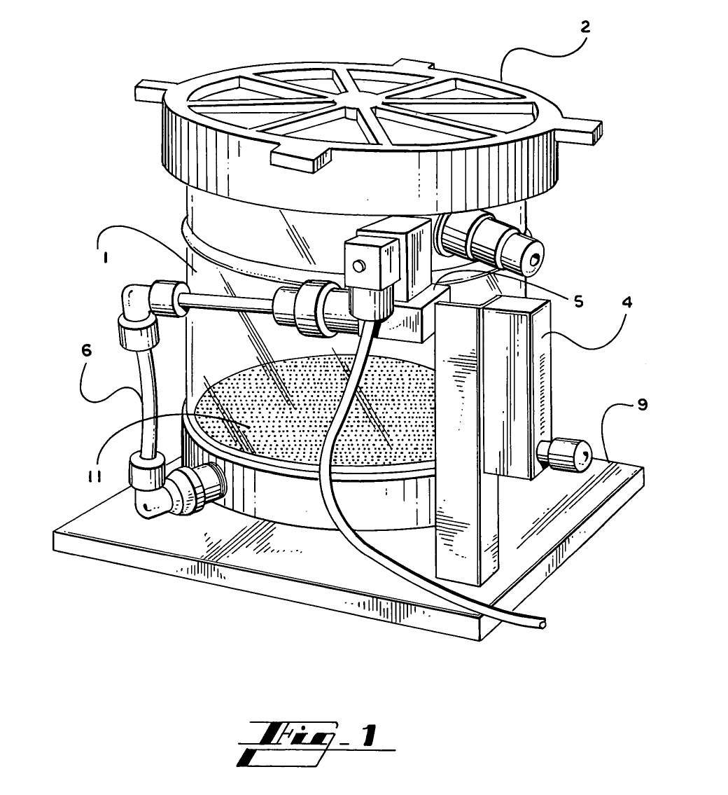

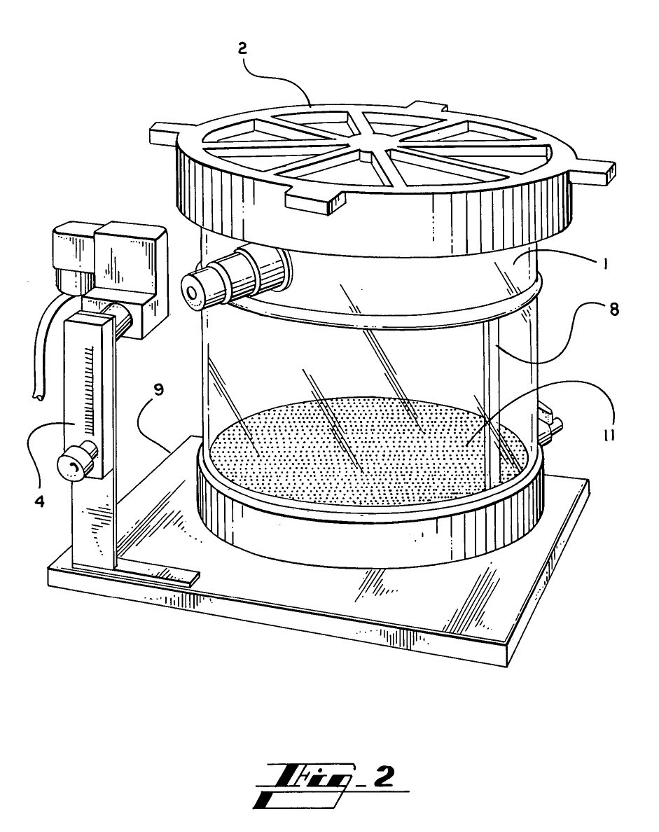

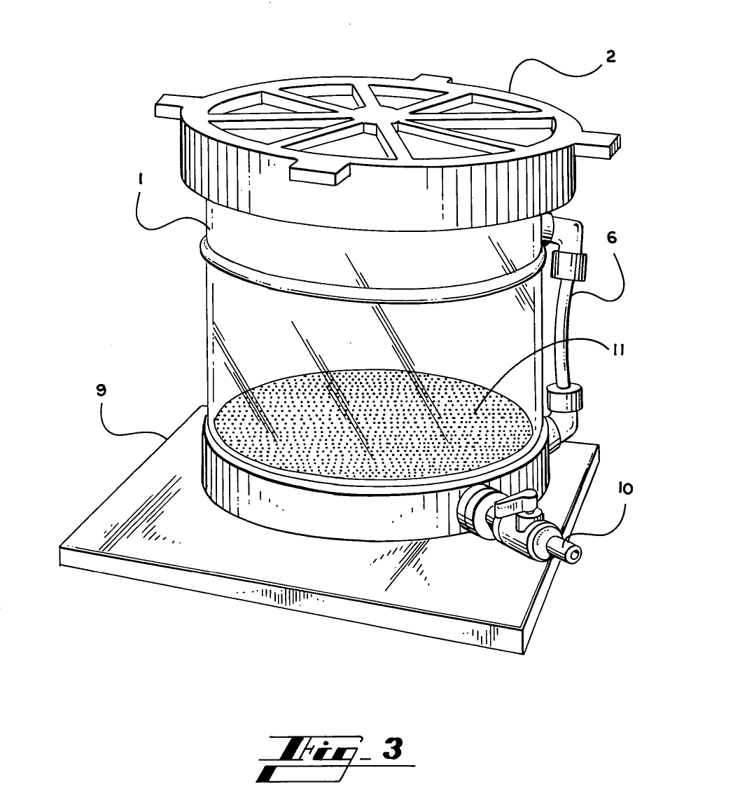

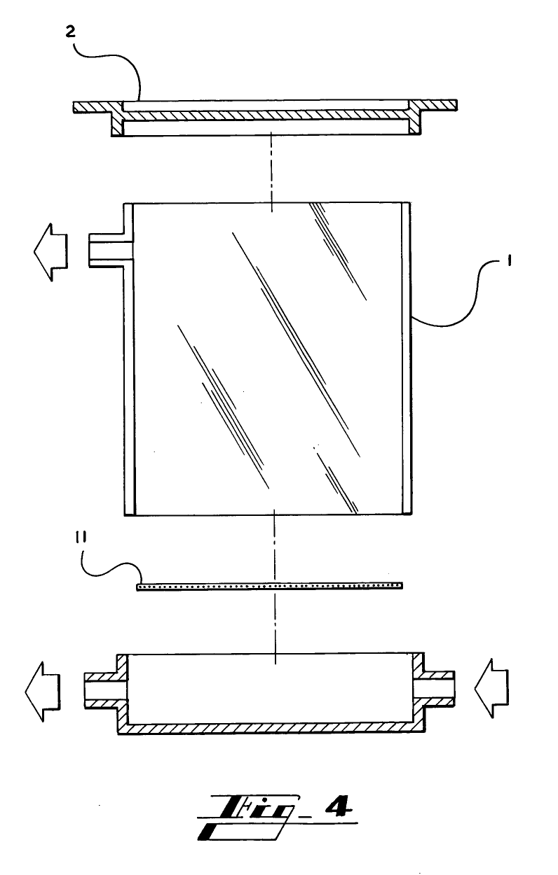

### REFERENCE TO A RELATED APPLICATION

This application claims the benefit of my copending provisional application 60/489,880 filed Jul. 24, 2003, which is relied on and incorporated herein by reference.

The present invention relates to a granular feeder apparatus for a swimming pool.

### BRIEF DESCRIPTION OF DRAWINGS

Figure I shows the apparatus of the present invention, illustrating the water inlet;

Figure II shows the apparatus of the present invention, illustrating the water outlet;

Figure III shows the apparatus of the invention, illustrating the system drain; and

Figure IV is a diagrammatic view of the flow system of the present invention.

### DETAILED DESCRIPTION OF THE INVENTION

In Figure I, there is shown the chamber 1, formed of an upstanding wall and having a cover 2, a water inlet 3, connected with a source of water (not shown) and a flow meter 4. Solenoid valve 5 functions to turn the granular feeder on and off. Piping 6 connects the source of water to the inlet 3.

In Figure II, there is shown the chamber 1 and the water outlet 7 for introducing the treated water into the swimming pool. The chamber 1 has a bottom 8 and can be conveniently fastened to a support 9 of any desired or conventional size or shape.

Figure III shows the chamber 1 fitted at its lowest level with a drain valve 10 for draining the system.

Inside of chamber 1, there is a grate or perforated plate 11 spaced from the bottom and supported by lugs, brackets or other supporting means which acts as a platform to retain the granular particles.

The flow diagram for the granular feeder of the present invention is shown in Figure IV. Untreated water enters the apparatus under pressure and at a flow rate of, for example, 5 to 30 gallons per hour for treating a swimming pool. The water flows underneath and up through the openings in the grate 11. The chamber is at an elevated pressure, for example 30-40 psi.

The granules or particles that can be used with the disclosed apparatus are about the size of crystallized sugar or one-third the size of a grain of rice. The size can vary as desired. The openings on the grate are dimensional so as to retain the solid granules. Examples of granules include sodium carbonate as the preferred material. However, the apparatus can also be used with other swimming pool additives such as BCDMH, Cal hypo and TCCA which are all well known in the industry.

The chamber, its top and bottom, can be made from any type of plastic such as PVC or the like. Preferably, the chamber itself is made of transparent plastic to enable operators to view the operation of the system.

1. The granular feeder apparatus comprising a chamber formed of at least one upstanding wall, a water inlet in said wall for communicating with said chamber, a water outlet in said wall, said chamber having a bottom, valve means for turning said granular feeder on and off, a flow meter connected to said chamber, a drain valve, for draining said feeder apparatus, a perforated plate, inside of and spaced from the bottom of said chamber to permit water to flow underneath and up through perforations in said plate and into said chamber.

2. The granular feeder apparatus according to claim 1 which further comprises a granular water treatment additive.

3. The granular feeder apparatus according to claim 2, wherein said additive is a member selected from the group consisting of sodium carbonate, BCDMH, cal hypo, and TCCA.

4. The granular feeder apparatus according to claim 1, wherein said chamber is made of transparent plastic.
